(19) United States
(12) Patent Application Publication
(10) Pub. No.: US 2010/0086347 A1
(43) Pub. Date: Apr. 8, 2010

(54) Ball Joint and Sealing Collar for Such a Ball Joint

(76) Inventors: Peter Bernhardt, Wuppertal (DE); Ulrich Mette, Essen (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/989,493

(22) PCT Filed: Jul. 10, 2006
(86) PCT No.: PCT/EP2006/006738

§ 371 Date: Jan. 25, 2008

(30) Foreign Application Priority Data
Jul. 27, 2005 (DE) 20 2005 011 802.8

(51) Int. Cl. F16C 11/00

(52) U.S. Cl. 403/134

(57) ABSTRACT

A ball joint includes a housing, a ball stud, a ball head, and a sealing collar which rests against the housing and the ball stud, in order to seal between the same, the sealing collar having an additional sealing section that is integrally formed therewith and additionally seals between the housing and the ball head.

### CROSS-REFERENCE TO RELATED APPLICATIONS

This application is a National Stage of International Application No. PCT/EP2006/006738 filed Jul. 10, 2006, which claimed priority to German Patent Application No. 20 2005 011 802.8 filed Jul. 27, 2005, the disclosures of both are incorporated herein by reference,

### BACKGROUND

Various embodiments of a ball join are described herein. In particular, the embodiments described herein relate to a ball joint and a sealing collar for such a ball joint.

Ball joints are known from the prior art and are used in a large variety of embodiments. In particular in the construction of motor vehicles, substantially all the ball joints have to be protected by sealing collars against dirt and moisture. Therefore, a sealing collar must, on the one hand, sealingly and reliably be attached to the joint housing and to the pivot pin, on the other hand, however, it must not restrict the options of the ball joint to move, or be damaged by movements of the joint.

The disadvantage of known vehicle ball joints including a sealing collar is that in the case of a leakage—and the penetration of liquid or particles associated therewith—or in the case of a destruction of the sealing collar, these ball joints very rapidly wear out.

### BRIEF SUMMARY

The present application describes various embodiments of a ball joint. A first embodiment creates a ball joint whose function is still ensured over a certain minimum period of time, even if the sealing collar is faulty.

For this purpose, the first embodiment provides a ball joint including a housing, a ball stud, a ball head, and a sealing collar which rests against the housing and the ball stud in order to seal between the same, the sealing collar having an additional sealing section that is integrally formed therewith and additionally seals between the housing and the ball head. In the case of a failure of the sealing collar, the additional sealing section of the sealing collar takes over the sealing function for the ball joint, whereby a safe function is ensured at least up to the next maintenance interval of the motor vehicle. On account of the additional sealing section, liquid and particles cannot penetrate into the space between the ball head and the housing, so that the ball joint is prevented from wearing out.

In one embodiment, a clamping ring is provided which fastens the sealing collar, whereby a safe and simple attachment of the sealing collar to the housing or the ball stud is ensured.

In another embodiment, there is provided a claw ring which fastens the sealing collar. In this arrangement the claw ring is not a separate component, but is integrated into the sealing collar. On account of the position of the claw ring in the interior of the sealing collar, the claw ring is protected against corrosion.

According to one embodiment the sealing collar engages a part of the housing, the part of the housing having a continuously surrounding protrusion. The continuously surrounding protrusion prevents the clamping or claw ring from shifting, and thus assists in the attachment of the sealing collar to the housing or the ball stud.

According to a further embodiment the sealing collar engages a part of the housing, the part of the housing including a surrounding edge that is inclined away from the ball head. Thus, the clamping or claw ring may be prevented from shifting.

In one embodiment, the additional sealing section of the sealing collar engages the housing and a bowl that receives the ball head. The additional sealing section of the sealing collar thus directly rests against the ball head and seals between the housing and the ball head at least up to the next maintenance interval of the motor vehicle.

The additional sealing section of the sealing collar may be configured such that it is situated within the sealing collar. “Within” denotes here the space that is formed between the housing, the sealing collar, and a ball neck. The ball neck is configured between the ball head and the ball stud. The additional sealing section of the sealing collar thus divides the space between the housing, the sealing collar and the ball neck into two chambers. In the case of a failure of the sealing collar, the additional sealing section of the sealing collar takes over the sealing function for the ball joint.

According to one embodiment, a part of the additional sealing section of the sealing collar may engage an edge of the housing. The additional sealing section of the sealing collar and, together therewith, the sealing collar itself is thus not able to shift or may only shift slightly, so that even in the case of an intense movement of the ball joint and large tensile loads related thereto, the sealing collar remains in its position and seals reliably.

Provided between the ball head and the ball stud is a ball neck that may be engaged by a part of the additional sealing section of the sealing collar. In this arrangement, the part of the additional sealing section of the sealing collar continuously engages the ball neck, thereby creating a large contact surface which serves to support the sealing collar even in the case of intense movements of the ball stud.

The additional sealing section of the sealing collar may be configured in an undulating shape in section, the additional sealing section of the sealing collar in particular being curved unevenly. Thereby, the movability and flexibility of the additional sealing section of the sealing collar is increased.

In one embodiment, there are provided two different greases, with a first grease being disposed in the region of the ball head, and a second grease being disposed in the region between the additional sealing section of the sealing collar and the sealing collar itself. Thus, the second grease is for example disposed in the space that is formed between the ball neck, the additional sealing section and the sealing collar; it may, however, also be present in the space between the sealing collar and the additional sealing section. In this arrangement, the first grease is a joint grease, whereas the second grease is a sealing grease. Thus, depending on the requirement a suitable grease may be used.

In another embodiment, a sealing collar for a ball joint includes an additional sealing section which extends inwardly in an undulating shape. Installed in a ball joint of a motor vehicle, the additional sealing section of the sealing collar, which is integrally formed with the sealing collar itself, may take over the sealing function for the ball joint in the case of a failure of the sealing collar, whereby a safe functioning at least up to the next maintenance interval of the motor vehicle is ensured.

Further features and advantages will be apparent from the sub-claims.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a partially sectioned view of a ball joint in accordance with the invention including a sealing collar in accordance with the invention according to a first embodiment,

FIG. 2 shows a longitudinal section through the sealing collar in FIG. 1,

FIG. 3 shows a sectional view of a ball joint in accordance with the invention including a sealing collar in accordance with the invention according to a second embodiment,

FIG. 4 shows a sectional view of a ball joint in accordance with the invention including a sealing collar in accordance with the invention according to a third embodiment,

FIG. 5 shows a longitudinal section through the sealing collar in FIG. 4,

FIG. 6 shows a sectional view of a ball joint in accordance with the invention including a sealing collar in accordance with the invention according to a fourth embodiment,

FIG. 7 shows a sectional view of a ball joint in accordance with the invention including a sealing collar in accordance with the invention according to a fifth embodiment,

FIG. 8 shows a longitudinal section through the sealing collar of FIG. 7,

FIG. 9 shows a sectional view of a ball joint in accordance with the invention including a sealing collar in accordance with the invention according to a sixth embodiment, and

FIG. 10 shows a longitudinal section through the sealing collar of FIG. 9.

### DETAILED DESCRIPTION OF THE INVENTION

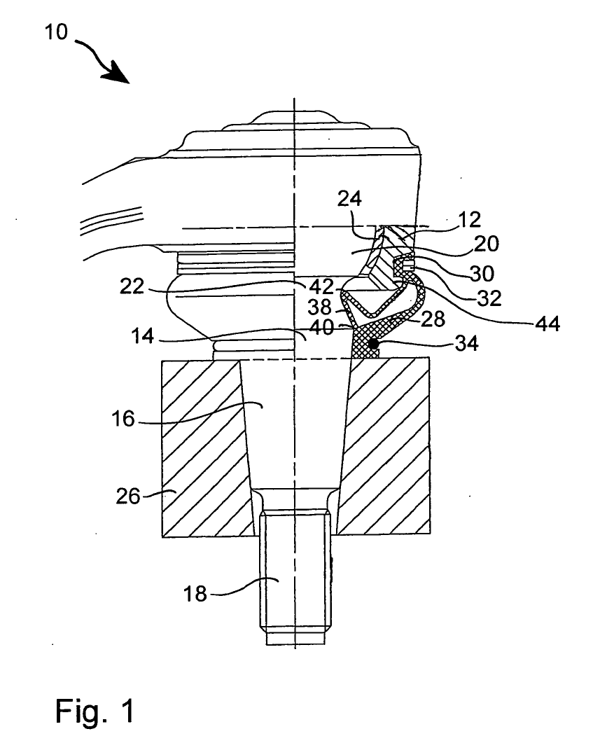

The ball joint 10 represented in FIG. 1 comprises as the essential components a housing 12 and a ball stud 14. The ball stud 14 includes a connecting bolt 16 which is adjoined by a thread 18 (schematically shown). A ball head 20 which is connected to the ball stud 14 via a ball neck 22 is received in a bowl 24 which in turn is fixed in the housing 12.

The ball joint 10 is attached to a component 26 which may, for example, be a part of a chassis for a motor vehicle. The ball stud 14 is inserted by its connecting bolt 16 and the thread 18 through the component 26 and may be attached to the latter by means of a nut (not shown).

A sealing collar 28 consists of an elastic material having sealing properties, and its upper side according to the representation in the figure is attached to the housing 12. For this purpose, the upper end of the sealing collar 28 is placed in a surrounding housing groove 30 and urged against the housing 12 by means of a clamping ring 32. At its lower side, the sealing collar 28 rests against a holding surface of the ball stud 14. A metal ring 34 presses the lower end of the sealing collar 28 against the holding surface of the ball stud 14.

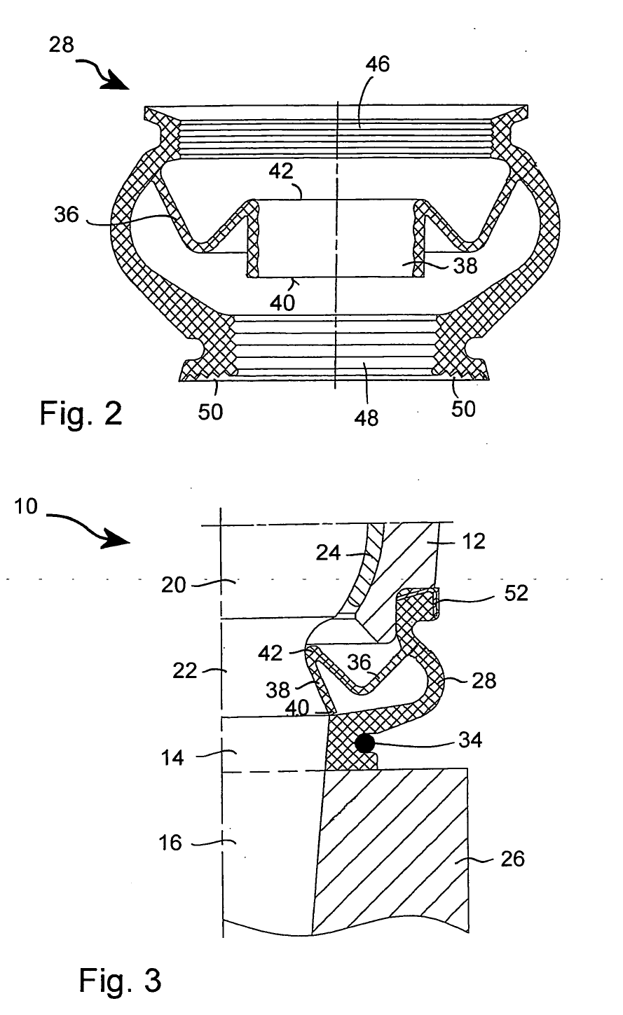

An additional sealing section 36 of the sealing collar 28 that is integrally formed with the latter is disposed in the space between the sealing collar 28, the housing 12, and the ball neck 22. In particular, the additional sealing section 36 of the sealing collar 28 is configured in an undulating shape (FIG. 2), with a part 38 resting against the ball neck 22 and continuously bearing against the latter.

An end piece 40 of the additional sealing section 36 of the sealing collar 28 engages the sealing collar 28.

A part 42 of the additional sealing section 36 of the sealing collar 28 further touches a rim of the bowl 24 which receives the ball head 20.

In the region of the clamping ring 32 the additional sealing section 36 of the sealing collar 28 rests against a protrusion 44 of the housing 12, the continuously surrounding protrusion 44 and the housing groove 30 preventing the clamping ring 32 from shifting and, as a consequence thereof, the sealing collar 28 from being detached.

Represented in FIG. 2 is a longitudinal section through the sealing collar 28 that is rotationally symmetrical with respect to a center axis A. The sealing collar 28 includes an upper axial opening 46 and a lower axial opening 48 that are profiled at their rims, in order to later on obtain a particularly tight and reliable connection in the radial direction. Placed in addition in the circumferential region of the lower axial opening 48 are downwardly protruding sealing lips 50 which ensure an axial sealing in the installed state.

The sealing collar 28 is installed in one work step axially from below (according to FIG. 1). In so doing, it is guided over the ball stud 14. The sealing collar 28 moves into the housing groove 30 and is attached to the housing by means of the clamping ring 32. Moreover, the sealing collar 28 is fastened to the ball stud 14 by means of the metal ring 34.

In FIG. 3, the sealing collar 28 is shown in a second embodiment which, in contrast to the first embodiment (FIGS. 1 and 2), comprises a claw ring 52 instead of a clamping ring 32. The claw ring 52 is integrated in the sealing collar 28 and does not have to be attached as a separate component. Furthermore, the housing 12 shown in FIG. 3 does not comprise a protrusion 44.

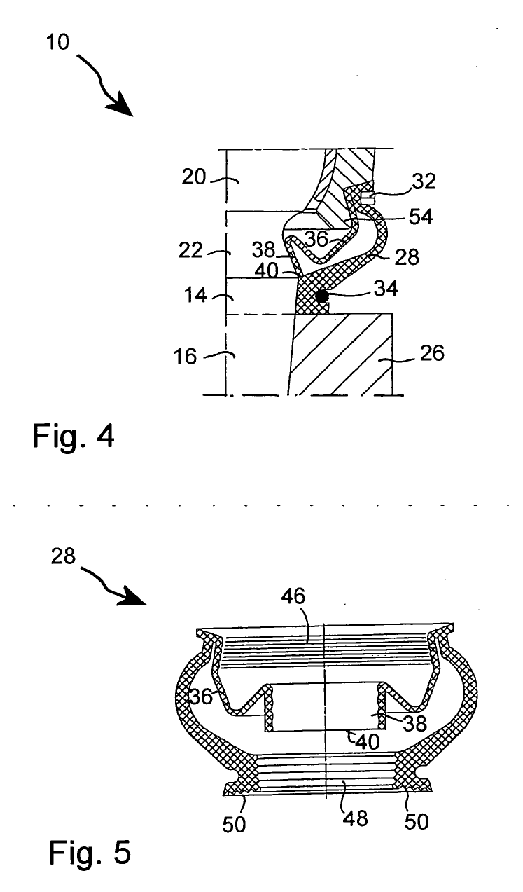

FIGS. 4 and 5 show a ball joint 10 in a third embodiment. In this arrangement, the housing 12 of the ball joint 10 has, in the region in which the sealing collar 28 is attached to the housing 12 by means of the clamping ring 32, a surrounding edge 54 that is inclined away from the ball head 20. Just like the protrusion 44 of the first embodiment (FIGS. 1 and 2), the edge 54 supports here the attachment of the sealing collar 28 to the housing 12 and prevents the clamping ring 32 and the sealing collar 28 from shifting.

Furthermore, in this arrangement the additional sealing section 36 of the sealing collar 28 has already been configured in the region of the clamping ring 32, so that the latter secures both the sealing collar 28 and the additional sealing section 36 of the sealing collar.

The additional sealing section 36 of the sealing collar 28 does not engage the edge of the bowl 24 that comprises the ball head 20. However, the contact surface of the part 38 of the additional sealing section 36 is so large that even with an intense movement of the ball joint 10 and tensile loads materializing in connection therewith, the additional sealing section 36 does not shift along the ball neck 22. A shifting of the additional sealing section 36 would result in the sealing function being impaired.

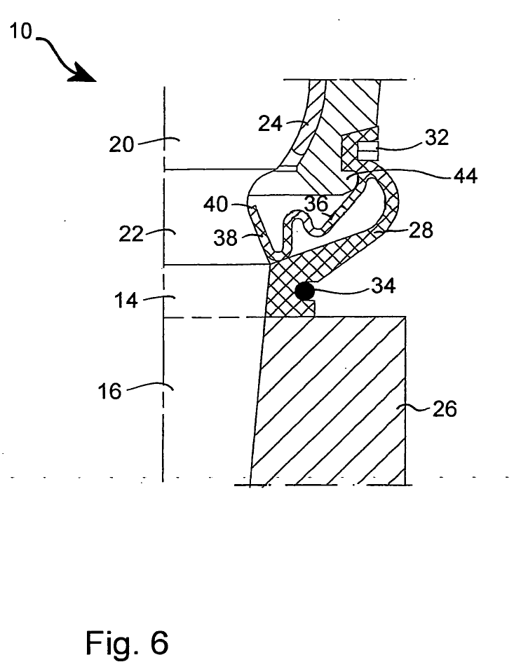

In FIG. 6, the ball joint 10 including the sealing collar 28 is shown in a fourth embodiment. Just like the first embodiment (FIGS. 1 and 2), the housing 12 of the ball joint 10 has the protrusion 44.

The end piece 40 of the additional sealing section 36 of the sealing collar 28 faces here towards the ball head 20. Moreover, in this arrangement the additional sealing section 36 of the sealing collar 28 is curved several times.

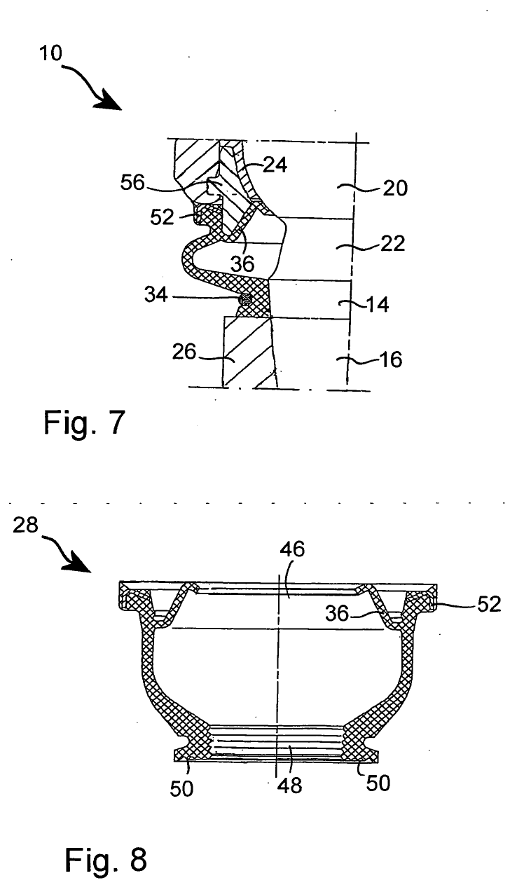

The two embodiments of the ball joint 10 shown in FIGS. 7 to 10 differ from the aforementioned embodiments by the additional sealing section 36 of the sealing collar 28 engaging the housing 12 and the bowl 24 that receives the ball head 20.

These embodiments (FIGS. 7 to 10) use two different greases. A first grease is provided in the region of the ball head 20, whilst a second grease is present in the space between the ball neck 22, the additional sealing section 36 of the sealing collar 28, and the sealing collar 28 itself. The first grease is a joint grease. The second grease is a sealing grease. Thus, the greases are adapted to the different requirements.

The additional sealing section 36 of the sealing collar 28 which is shown in FIGS. 7 and 8 leans in sections against the ball head 20. In this arrangement, the housing 12 is configured in several parts and has a closure ring 56. Further provided is a claw ring 52 instead of a clamping ring 32.

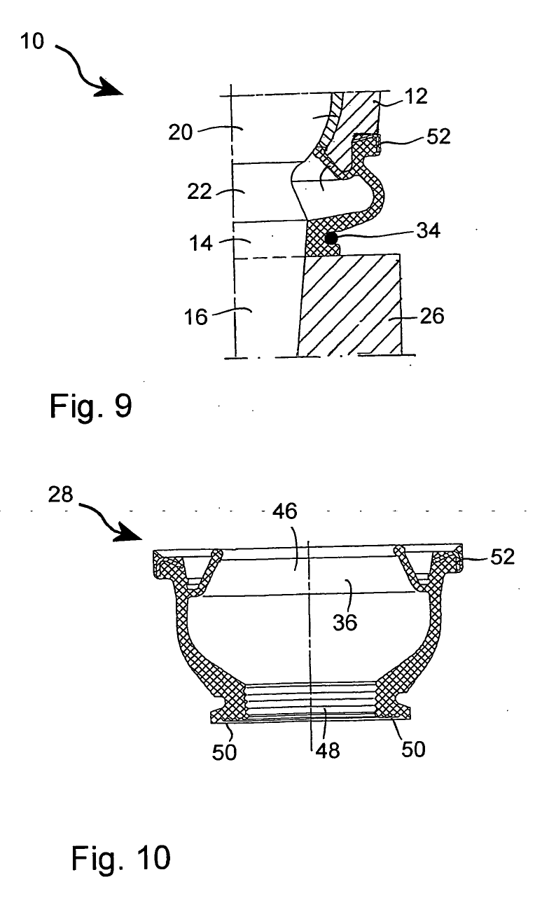

The sixth embodiment of the ball joint 10 shown in FIGS. 9 and 10 has a sealing collar 28 which is again attached to the housing 12 by means of a claw ring 52. The end piece 40 of the additional sealing section 36 of the sealing collar 28 engages the ball head 20.

In the case of a failure of the sealing effect of the sealing collar 28, the embodiments shown in FIGS. 7 to 10 may likewise seal between the housing 12 and the ball head 20.

In accordance with the provisions of the patent statutes, the principle and mode of operation of the ball joint have been explained and illustrated in its various embodiments. However, it must be understood that the ball joint described herein may be practiced otherwise than as specifically explained and illustrated without departing from its spirit or scope.

1. A ball joint comprising a housing, a ball stud, a ball head, and a sealing collar which rests against the housing and the ball stud in order to seal between the same, the sealing collar including an additional sealing section that is integrally formed therewith and additionally seals between the housing and the ball head.

2. The ball joint according to claim 1, wherein there is provided a clamping ring that secures the sealing collar.

3. The ball joint according to claim 1, wherein there is provided a claw ring that secures the sealing collar.

4. The ball joint according to claim 1, wherein the sealing collar engages a part of the housing, the part of the housing having a continuously surrounding protrusion.

5. The ball joint according to claim 1, wherein the sealing collar engages a part of the housing, the part of the housing including a surrounding edge that is inclined away from the ball head.

6. The ball joint according to claim 1, wherein the additional sealing section of the sealing collar engages the housing and a bowl that receives the ball head.

7. The ball joint according to claim 1, wherein the housing has a closure ring.

8. The ball joint according to claim 1, wherein the additional sealing section of the sealing collar is configured in such a manner that it is situated within the sealing collar.

9. The ball joint according to claim 8, wherein a part of the additional sealing section of the sealing collar may engage an edge of the housing.

10. The ball joint according to claim 8, wherein between the ball head and the ball stud there is provided a ball neck which is engaged by a part of the additional sealing section of the sealing collar.

11. The ball joint according to claim 8, wherein the additional sealing section of the sealing collar includes an end piece, the end piece engaging the sealing collar.

12. The ball joint according to claim 8, wherein the additional sealing section of the sealing collar includes an end piece, the end piece pointing away from the sealing collar.

13. The ball joint according to claim 8, wherein the additional sealing section of the sealing collar is configured in an undulating shape in section.

14. The ball joint according to claim 1, wherein two different greases are provided, a first grease being disposed in the region of the ball head, and a second grease being disposed in the region between the additional sealing section of the sealing collar and the sealing collar itself.

15. A sealing collar for a ball joint including an additional sealing section that extends inwardly in an undulating shape.
